(19) United States
(12) Patent Application Publication
(10) Pub. No.: US 2026/0162058 A1
(43) Pub. Date: Jun. 11, 2026

(54) AUTOMATICALLY DETERMINING SOURCING EVENT TEMPLATES USING MACHINE LEARNING

(71) Applicant: SAP SE, Walldorf (DE)

(72) Inventors: Kumaraswamy Gowda, Bangalore (IN); Sahana N, Bengaluru (IN); Rajendra Vuppala, Dublin, CA (US); Potta Reddy Vijaya Bharathi Reddy, Bengaluru (IN)

(21) Appl. No.: 18/976,740

(22) Filed: Dec. 11, 2024

(51) Int. Cl. G06Q 10/087

(52) U.S. Cl. CPC G06Q 10/087

(57) ABSTRACT

The present disclosure involves systems, software, and computer implemented methods for automatically determining sourcing event templates using machine learning. One example method includes training, using automatically-identified historical sourcing event data, a sourcing event template recommendation model to automatically recommend, from among a plurality of candidate sourcing event templates, a sourcing event template object for an upcoming sourcing event. Sourcing event field data is automatically extracted, using a sourcing event field extraction model, from a request to create the first upcoming sourcing event. Extracted sourcing event field data is provided to the sourcing event template recommendation model, which provides a first recommended sourcing event template for the first upcoming sourcing event. A sourcing event object is automatically created in a sourcing system for the first upcoming sourcing event, based on the extracted sourcing event field data for the first upcoming sourcing event and the first recommended sourcing event template.

### TECHNICAL FIELD

The present disclosure relates to computer-implemented methods, software, and systems for automatically determining sourcing event templates using machine learning.

### BACKGROUND

Strategic sourcing can be performed by a company to monitor and evaluate sourcing strategies. Sourcing strategies can include determining from which entity to purchase items that need to be procured. Strategic sourcing can include supply chain management, supplier development, contract negotiation, and outsourcing evaluation. Existing sourcing event creation scenarios can have numerous inherent problems. For example, a user may perform many manual, potentially error-prone steps for sourcing event creation. Thus, a database of sourcing event objects may include multiple sourcing event objects that have erroneous data.

### SUMMARY

The present disclosure involves systems, software, and computer implemented methods for automatically creating sourcing events from free-form data. One example method includes: automatically identifying, for a first organization, historical sourcing event data that includes sourcing event field values, line item values, and historical sourcing event template selections for historical sourcing events; training, using the automatically-identified historical sourcing event data, a machine-learning sourcing event template recommendation model for the first organization to automatically recommend, from among a plurality of candidate sourcing event templates, a sourcing event template object for an upcoming sourcing event; automatically identifying, using a machine-learning sourcing event creation intent model, a request to create a first upcoming sourcing event; in response to automatically identifying the request to create the first upcoming sourcing event, automatically extracting, using a machine-learning automatic sourcing event field extraction model, extracted sourcing event field data from the request to create the first upcoming sourcing event; providing extracted sourcing event field data for the first upcoming sourcing event to the machine-learning sourcing event template recommendation model; receiving, from the machine-learning sourcing event template recommendation model, a first recommended sourcing event template for the first upcoming sourcing event; and automatically creating a sourcing event object in a sourcing system for the first organization for the first upcoming sourcing event, based on the extracted sourcing event field data for the first upcoming sourcing event and the first recommended sourcing event template.

Implementations may include one or more of the following features. The historical sourcing event data can be preprocessed. Training the machine-learning sourcing event template recommendation model can include determining feature weights, for sourcing event template recommendation for the first organization, of features in the historical sourcing event data. The feature weights can identify features that can determine, for the first organization, a best sourcing event template for an upcoming sourcing event. The features can include commodity, category, department, currency, baseline spend, and line item information of historical sourcing events. The features can include recency data for historical selections of sourcing event templates. The machine-learning sourcing event template recommendation model can be a XG Boost model or a convolutional XG Boost model. The request to create the sourcing event can be a free-form text message. A recommendation to use the first recommended sourcing event template can be provided to a user of the first organization and confirmation from the user can be received for using the first recommended sourcing event template. The sourcing event object for the first upcoming sourcing event can be created based on the first recommended sourcing event template in response to receiving the confirmation. A second recommended sourcing event template for a second upcoming sourcing event can be receive from the sourcing event template recommendation model. A recommendation to use the second recommended sourcing event template for the second upcoming sourcing event can be provided to a user of the first organization. A rejection can be received from the user regarding using the second recommended sourcing event template for the second upcoming sourcing event. The machine-learning sourcing event template recommendation model can determine, in response to the rejection, a third recommended sourcing event template for the second upcoming sourcing event. The machine-learning sourcing event template recommendation model can be updated based on the rejection.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for automatically creating sourcing events from free-form data.

FIG. 2 is a flowchart of an example process for automatically creating sourcing events from free-form data.

FIG. 3 illustrates an example system for automatically creating sourcing events from free-form data.

FIG. 4 illustrates an example user interface for annotating example text with event field labels.

FIG. 5 illustrates an example system for automatic sourcing event template selection.

FIG. 6 illustrates example features for automatic sourcing event template selection.

FIG. 7 is a flowchart of an example method for creating sourcing event objects from free-form data.

FIG. 8 is a flowchart of an example method for automatic sourcing event template selection.

### DETAILED DESCRIPTION

A buyer at an organization may want to procure item(s) for the organization. The buyer may want to find a supplier who can provide the item(s) at a lowest price. Other factors can influence selection of a supplier, such as past interactions, overall reputation, delivery time factors, etc. Strategic sourcing can be a process for trying to find a best supplier for the organization for a set of one or more items that the organization wants to procure. After performing the strategic analysis, a supplier can be selected and awarded a sourcing opportunity.

An input to strategic sourcing can be a sourcing event. Sourcing event creation can be a tedious and error-prone process. For example, a first user (e.g., a user in a procurement organization) may receive a free-form request (e.g., in an email message or some other type of free-form message, such as an instant message, chat message, etc.). The first user may realize that the free-form request corresponds to a sourcing event creation request and forward the request to a second user, such as a sourcing agent. The sourcing agent can open a sourcing application, review the sourcing event creation request, and manually create a sourcing event in the sourcing application. The sourcing event be published to suppliers, who can perform a sourcing bidding process based on the sourcing event.

Existing sourcing event creation scenarios can have numerous inherent problems. For example, the first user may, in general, receive many hundreds of emails or other messages in a given time period, with many emails or messages not being related to sourcing event creation. The first user may miss identifying, among many received messages, a given email or message as corresponding to a sourcing event creation request. For those messages the first user identifies, the first user processing a given email or message may occur after a substantial delay, as the user navigates through all of the messages they have received. The first user may not be a sourcing expert (e.g., the first user might not have as much sourcing expertise as the sourcing agent) and may therefore miss identifying some sourcing event creation request messages.

As another example, existing processes for sourcing agents creating sourcing events can involve many repetitive and time-consuming steps. For example, after receiving a sourcing event creation request, the sourcing agent can log into a sourcing application, navigate to a sourcing event creation interface, and perform a number of manual steps including inputting data into fixed data entry fields of the sourcing event creation interface. For instance, the manual steps can include entry of event parameters for the sourcing event, entry of line item information for each line item of the sourcing event, and identification and selection of an appropriate template for an event type of the sourcing event. In some cases, rather than or in addition to manual line item information entry, the sourcing agent can identify and select a line item spreadsheet (e.g., which may be an attachment to a forwarded sourcing event creation request), upload the spreadsheet, and associate the uploaded spreadsheet with the sourcing event. The manual sourcing event creation by the sourcing agent can include manual entry for dozens if not hundreds of fields, which can result in an error-prone and time and resource consuming process, even for experienced users, and much more so for novice users.

Additionally, template identification and selection can include specific time-consuming and error prone tasks and overall problems. For example, a given organization may have hundreds of templates, and a user, based on inexperience or being overwhelmed by a vast number of options, may select an inappropriate, incorrect, or less than optimal template. A template can include predefined rules, settings, terms, or other content that may be applied to the sourcing event. An organization can use templates to reuse certain configurations for multiple instances of similar sourcing events, for example. Selecting correct templates can be important for an organization, and relying on manual user selection of a template among hundreds of candidate templates can result in misconfigurations, errors, and/or inconsistencies.

To solve inherent problems with sourcing event creation and template selection for sourcing events, an organization can use automated sourcing event creation and automated sourcing event template selection solutions. The automated sourcing event creation solution can include automatically identifying a sourcing event creation request from a free-form message received by a user, notifying the user of the identified sourcing event creation request, receiving a confirmation from the user to automatically create a sourcing event based on content of the free-form message, and automatically creating the sourcing event in response to receiving the user confirmation. The automated sourcing event creation solution can include a machine learning pipeline that includes different trained machine learning engines, including a trained sourcing event creation intent engine and a sourcing event parameter extraction engine. The automated sourcing event template selection solution can include use of specific machine learning models trained for template recommendation. An instance of each type of machine learning engine or model described above can be trained and used for different customers of a sourcing application and for different languages.

The automated sourcing event creation and automated sourcing event template selection solutions can provide various advantages. Automatic identification of user messages that correspond to sourcing event creation requests can result in reduction of failures to identify such messages. Automatic sourcing event creation from content of a free-form message can enable initiation of sourcing event creation from various types of communication mediums such as email messages, chat messages, or other types of free-form messages. Automatic creation of sourcing events can result in reduced resource consumption (as compared to user use of numerous input fields or interfaces), reduced errors, and faster sourcing event creation. The sourcing event template selection solution can result in reliable and accurate template selection, thereby reducing selection and use of incorrect templates and resulting problems from subsequent errors or inefficiencies and potential reconfiguration after an incorrect template is deployed. Machine learning pipelines can include language agnostic and customer-specific models that are tailored for given customers and customer contexts.

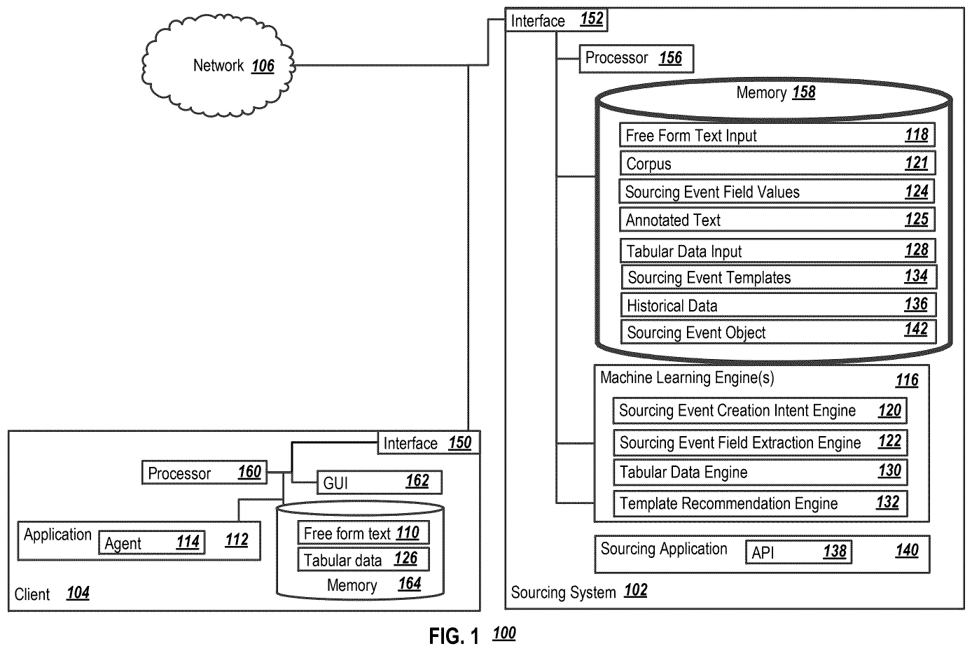

FIG. 1 is a block diagram illustrating an example system 100 for creating sourcing events from free-form data. Specifically, the illustrated system 100 includes or is communicably coupled with a sourcing system 102, a client device 104, and a network 106. Although shown separately, in some implementations, functionality of two or more systems or servers may be provided by a single system or server. In some implementations, the functionality of one illustrated system or server may be provided by multiple systems or servers.

A user of an organization can view a free-form text item 110 in an application 112. The free-form text item 110 can be an email message, a chat message, or some other type of free-form message. The application 112 can be an email application, a chat application, or some other type of application in which free-form text items can be received and viewed. The user may receive many hundreds of text items and may miss or misinterpret some free-form text items that represent a request to create a sourcing event in the sourcing system 102. To avoid the user missing free-form text items that represent requests to create sourcing events, and to otherwise add efficiency and reduce errors, an automated approach can be used to automatically create sourcing events from free-form data. A sourcing event can be an auction request, a request for information (RFI), a request for a proposal, or a request for quotation (which can all generically be referred to as RFX (e.g., request for “X”).

For example, an agent 114 connected to the application 112 can automatically process free-form text items received by the application 112, including the free-form text item 110. In some cases, the agent 114 can send the free-form text item to the sourcing system 102 for processing by a set of machine learning engines 116. In other cases, some or all of AI/ML processing may be performed by the agent 114 on the client device 104. Discussions below are described as the sourcing system 102 receiving the free-form text item 110 as a free-form text input 118 and subsequent processing by the set of machine learning engines 116 of the free-form text input 118. Although the agent 114 is shown as executing on the client device 104, the agent 114 can also operate, for example, on a server, as a cloud service, etc.

The sourcing system 102 can receive and process the free-form text input 118 after the user (and the organization of the user in general) have given consent for such processing. The sourcing system 102 can use a sourcing event creation intent engine 120 to analyze the free-form text input 118 to determine whether the free-form text input 118 corresponds to a request to create a sourcing event. The sourcing event creation intent engine 120 can be trained using a corpus 121.

If the sourcing event creation intent engine 120 determines that the free-form text input 118 corresponds to a request to create a sourcing event, the free-form text input 118 can be provided to a sourcing event field extraction engine 122. The sourcing event field extraction engine 122 can automatically extract sourcing event field values 124 from the free-form text input 118. The sourcing event field extraction engine 122 can be trained using annotated text 125.

The free-form text input 118 may have line item information for the sourcing event, and in such cases, the sourcing event field extraction engine 122 can automatically extract the line item information. As another example, the free-form text item 110 received by the application 112 may have associated tabular data 126 (e.g., as an email attachment), and the sourcing system 102 may therefore receive tabular data input 128 in combination with the free-form text input 118. A tabular data engine 130 can automatically extract line item information from the tabular data input 128, either based on fixed, expected field definitions or by using AI/ML techniques to automatically identify line item information in a tabular format used by the user but not previously known to the sourcing system 102.

The sourcing system 102 can use a template recommendation engine 132 to automatically recommend a sourcing event template for creation of a sourcing event. The sourcing system may include hundreds of templates 134, for example, and the user of the client device 104 may not know which template to select. The template recommendation engine 132 can be or include a trained AI/ML model trained on historical data 136. Template recommendation is described in more detail below.

The sourcing system 102 can automatically invoke an API 138 of a sourcing application 140 to request creation of a sourcing event in the sourcing system 102. The sourcing system 102 can pass, to the API 138, the sourcing event field values 124, an indication of the template identified by the template recommendation engine 132, and extracted line item information, as appropriate. The sourcing application 140 can receive the API request and create a sourcing event object 142 in the sourcing system 102 in response to the API request. The sourcing system 102 can also generate supplier recommendations, as described below.

The sourcing system 102 can update models in the set of machine learning engines 116 over time, based on user feedback and/or based on more recent training data. As mentioned, the sourcing system 102 can maintain organization-specific weights for each organization for which the sourcing system 102 provides sourcing functionality. The corpus 121 can be periodically updated, to reflect current sourcing/procurement terminology. Further details regarding the set of machine learning engines 116 are provided below.

As used in the present disclosure, the term “computer” is intended to encompass any suitable processing device. For example, although FIG. 1 illustrates a single sourcing system 102, and a single client device 104, the system 100 can be implemented using a single, stand-alone computing device, two or more sourcing systems 102, or two or more client devices 104. Indeed, the sourcing system 102 and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the sourcing system 102 and the client device 104 may be adapted to execute any operating system, including Linux, UNIX, Windows, Mac OS®, Java™, Android™, iOS or any other suitable operating system. According to one implementation, the sourcing system 102 may also include or be communicably coupled with an e-mail server, a Web server, a caching server, a streaming data server, and/or other suitable server.

Interfaces 150 and 152 are used by the client device 104 and the sourcing system 102, respectively, for communicating with other systems in a distributed environment—including within the system 100—connected to the network 106. Generally, the interfaces 150 and 152 each comprise logic encoded in software and/or hardware in a suitable combination and operable to communicate with the network 106. More specifically, the interfaces 150 and 152 may each comprise software supporting one or more communication protocols associated with communications such that the network 106 or interface's hardware is operable to communicate physical signals within and outside of the illustrated system 100.

The sourcing system 102 includes one or more processors 156. Each processor 156 may be a central processing unit (CPU), a blade, an application specific integrated circuit (ASIC), a field-programmable gate array (FPGA), or another suitable component. Generally, each processor 156 executes instructions and manipulates data to perform the operations of the sourcing system 102. Specifically, each processor 156 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Python, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The sourcing system 102 includes memory 158. In some implementations, the sourcing system 102 includes multiple memories. The memory 158 may include any type of memory or database module and may take the form of volatile and/or non-volatile memory including, without limitation, magnetic media, optical media, random access memory (RAM), read-only memory (ROM), removable media, or any other suitable local or remote memory component. The memory 158 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the sourcing system 102.

The client device 104 may generally be any computing device operable to connect to or communicate with the sourcing system 102 via the network 106 using a wireline or wireless connection. In general, the client device 104 comprises an electronic computer device operable to receive, transmit, process, and store any appropriate data associated with the system 100 of FIG. 1. The client device 104 can include one or more client applications, including the application 112. A client application is any type of application that allows the client device 104 to request and view content on the client device 104. In some implementations, a client application can use parameters, metadata, and other information received at launch to access a particular set of data from the sourcing system 102. In some instances, a client application may be an agent or client-side version of the one or more enterprise applications running on an enterprise server (not shown).

The client device 104 further includes one or more processors 160. Each processor 160 included in the client device 104 may be a central processing unit (CPU), an application specific integrated circuit (ASIC), a field-programmable gate array (FPGA), or another suitable component. Generally, each processor 160 included in the client device 104 executes instructions and manipulates data to perform the operations of the client device 104. Specifically, each processor 160 included in the client device 104 executes the functionality required to send requests to the sourcing system 102 and to receive and process responses from the sourcing system 102.

The client device 104 is generally intended to encompass any client computing device such as a laptop/notebook computer, wireless data port, smart phone, personal data assistant (PDA), tablet computing device, one or more processors within these devices, or any other suitable processing device. For example, the client device 104 may comprise a computer that includes an input device, such as a keypad, touch screen, or other device that can accept user information, and an output device that conveys information associated with the operation of the sourcing system 102, or the client device 104 itself, including digital data, visual information, or a GUI 162.

The GUI 162 of the client device 104 interfaces with at least a portion of the system 100 for any suitable purpose, including generating a visual representation of the application 112. In particular, the GUI 162 may be used to view and navigate various Web pages, or other user interfaces. Generally, the GUI 162 provides the user with an efficient and user-friendly presentation of business data provided by or communicated within the system. The GUI 162 may comprise a plurality of customizable frames or views having interactive fields, pull-down lists, and buttons operated by the user. The GUI 162 contemplates any suitable graphical user interface, such as a combination of a generic web browser, intelligent engine, and command line interface (CLI) that processes information and efficiently presents the results to the user visually.

Memory 164 included in the client device 104 may include any memory or database module and may take the form of volatile or non-volatile memory including, without limitation, magnetic media, optical media, random access memory (RAM), read-only memory (ROM), removable media, or any other suitable local or remote memory component. The memory 164 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 104.

There may be any number of client devices 104 associated with, or external to, the system 100. For example, while the illustrated system 100 includes one client device 104, alternative implementations of the system 100 may include multiple client devices 104 communicably coupled to the sourcing system 102 and/or the network 106, or any other number suitable to the purposes of the system 100. Additionally, there may also be one or more additional client devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the client device 104 is described in terms of being used by a single user, this disclosure contemplates that many users may use one computer, or that one user may use multiple computers.

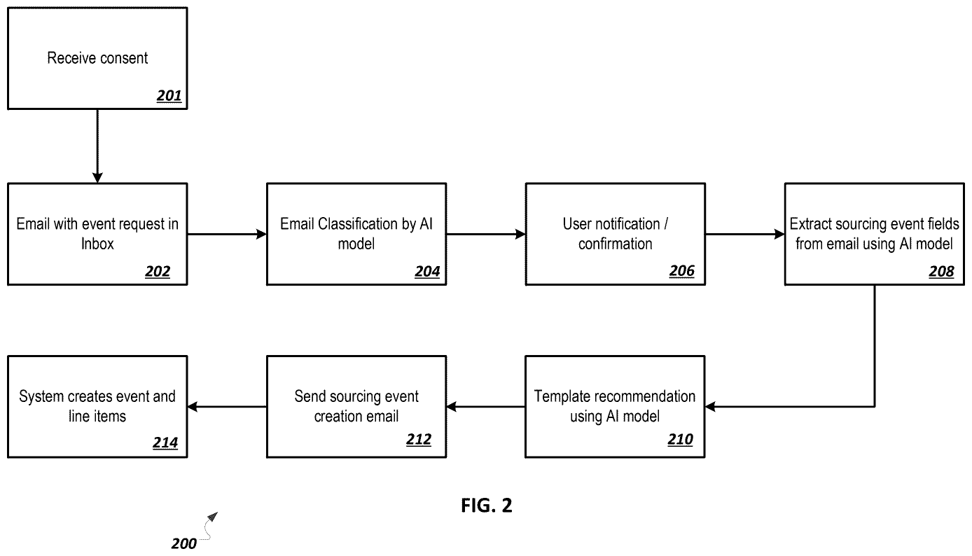

FIG. 2 is a flowchart of an example process 200 for automatically creating sourcing events from free-form data. At 201, the sourcing system can receive consent from a user (and from the organization of the user in general) to process free-form messages of the user (e.g., to process the user's received email messages, chat messages, or other free-form messages). The remainder of discussion of the process 200 will refer to processing of a user's emails but the process 200 can be performed for chat or other free-form messages.

At 202, the sourcing system identifies an email message with a sourcing event request in the user's email inbox. The sourcing system can process all email messages of a user as email messages arrive in the user's email inbox or can periodically (e.g., hourly) process messages in the user's email inbox.

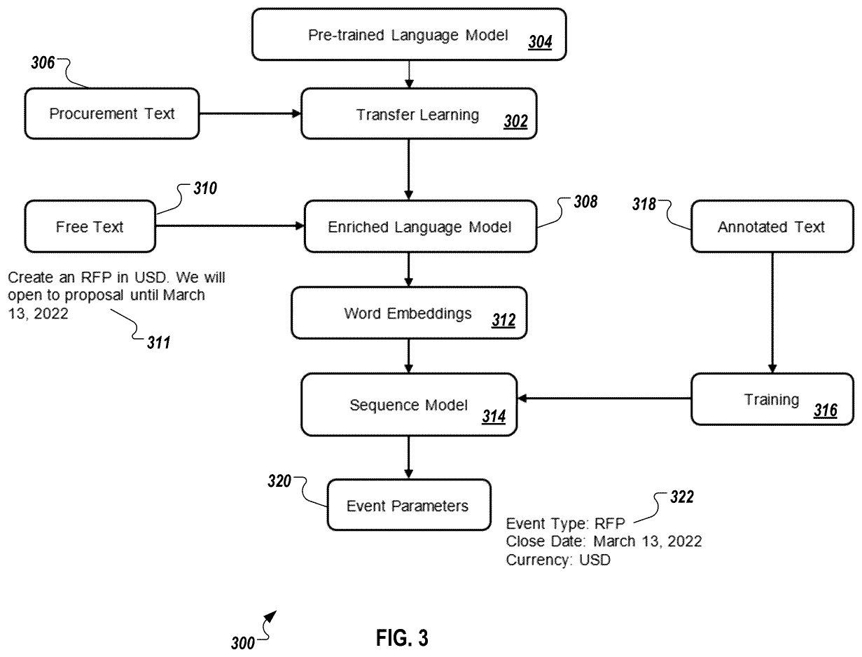

At 204, the sourcing system uses a trained ML engine (e.g., the sourcing event creation intent engine 120 of FIG. 1) to classify the email message as corresponding to a request to create a sourcing event. Embeddings of the email message can be provided to the sourcing event creation intent engine 120, for example, and the sourcing event creation intent engine 120 can output a classification of the email message of “corresponds to a request to create a sourcing event.” As another example, for email messages that do not correspond to sourcing events, an output classification can be “does not correspond to a request to create a sourcing event”. In general, the sourcing system can use different types of AI approaches for classifying the email message, including large language models, natural language processing, a Naïve Bayes model, etc. A trained model such as the sourcing event creation intent engine 120 can be trained based on a corpus, for example. The corpus, which can be the corpus 121 of FIG. 1, can include entries for words in a procurement domain, data obtained from public sources, product documentation of procurement, sourcing, or other related products, etc. The free-form text of the email message can be provided to the trained model, for instance, after possible pre-processing. Pre-processing can include tokenization, cleaning, normalization (e.g., lemmatization, stemming), etc. Intent classification is described in more detail below with respect to FIG. 3.

At 206, the sourcing system sends a notice to the user (e.g., using an email, text, in-application, or other type of message) about the automatic classification of the email message as corresponding to a request to create a sourcing event and a notice that the sourcing system plans to automatically create a sourcing event based on content of the identified email message. The sourcing system can receive a confirmation/acceptance from the user regarding the automatic sourcing event creation. In some cases, the sourcing system can proceed towards automatic sourcing event creation without explicit user acceptance, such as if a confidence level of classifying the email message as a request to create a sourcing event is more than a threshold. In some cases, the sourcing system sends a notification that a sourcing event will be created, for example. In some cases, the sourcing system only proceeds towards automatic sourcing event creation upon receiving a user confirmation/acceptance. In some cases, a confidence level of classifying the email message as a request to create a sourcing event exceeds a first threshold (e.g., indicating a likelihood of the email message corresponding to a request to create a sourcing event) but does not exceed a second threshold. In such cases, the sourcing system may ask for user confirmation. For instance, the first threshold may be 90% and the second threshold may be 98%. The sourcing system can, for example, determine that the email message likely corresponds to a request to create a sourcing event if the confidence level is at least 90%, but the sourcing system can proceed directly to automatic sourcing event creation without user confirmation only if the confidence level is at least 98%.

At 208, the sourcing system extracts sourcing event fields from the free text of the email message using an AI model. Event fields can correspond to object headers or other fields of a sourcing event object. Example event fields can include event title, event type (e.g., RFI (Request for Information), RFP (Request for Proposals), Auction, etc.), event opening date, event closing date, region, currency, commodity, or other fields.

The AI model can be a deep learning model that has been trained on annotated text, for example, as described in more detail below. The AI model can use different types of AI/ML approaches or technologies, such as sequence modeling, LSTM (Long Short-Term Memory) models, Softmax layers, feed-forward approaches, etc. Learned weights from a training phase can be loaded for use during classification. The deep learning model can tag each token in the free-form text to a classifier in a class set that includes an “unknown” classification for those tokens that cannot be mapped to another classification. Other mappings of tokens to classifications other than unknown can be considered as identification of sourcing event parameters.

The sourcing system can also identify line item fields from the email message and/or from attachments to the email message. The sourcing system can use the AI model to identify and extract line item information that may be included in the body of the email message. As another example, if the email message includes an attachment in a tabular form (e.g., a spreadsheet), the sourcing system can use models of the tabular data engine 130 of FIG. 1 to extract line item information. In some implementations, the sourcing system can identify recommended suppliers that can supply items represented by the identified line item information, based on region, commodity, and possible other identified sourcing event field information.

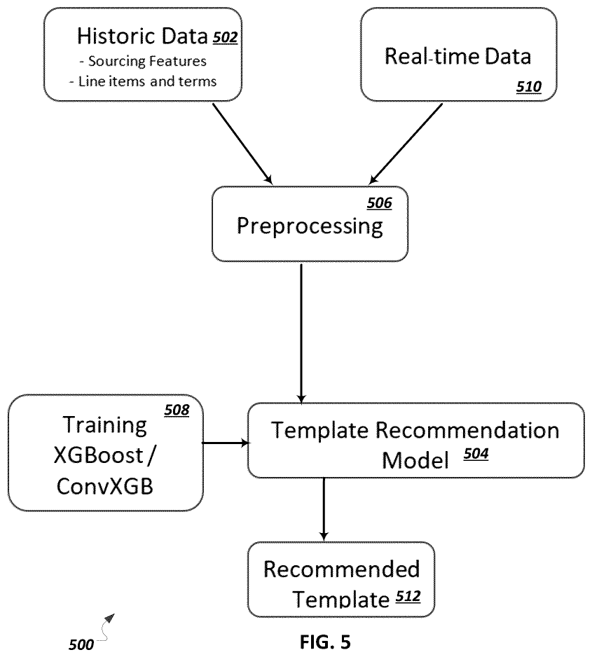

At 210, the sourcing system uses an AI model to recommend a template for sourcing event creation. Template recommendation is described in more detail below with respect to FIGS. 5, 6, and 8.

At 212, the sourcing system can send a sourcing event creation email message (or other notification) to the user that notifies the user that a sourcing object is to be (or has been) created. In some cases, the user can provide, in response to the notification, a further confirmation that a sourcing event with specified details should be created. In other cases, the sourcing system sends a notification-only message about sourcing event creation, without relying on a user response to proceed to create the sourcing event. In some cases, the user notification is sent before sourcing event creation and in other cases, the notification is sent after sourcing event creation (and may include a status confirmation of sourcing event creation success).

At 214, the sourcing system creates the sourcing event and any associated line items. The sourcing system 214 can invoke an API of a sourcing application and pass, as parameters of sourcing event/line item creation API requests, information extracted from the email message (and possibly a message attachment).

FIG. 3 illustrates an example system for automatically creating sourcing events from free-form data. In a transfer learning (e.g., training) phase 302, a pre-trained language model 304 is trained using procurement text 306 from a corpus to generate an enriched language model 308 that is trained to identify a free form message as being related to a request to create a sourcing event. In a classification stage, free-form text 310 is provided to the enriched language model 308 and the enriched language model 308 can determine that the free-form text 310 is related to a request to create a sourcing event. An example free text instance 311 has text of:
“Create an RFP in USD. We will open to proposal until March 13, 2022”.

In some cases, word embeddings of the free-form text 310 are provided to the enriched language model 308 (in other cases, an engine that uses the enriched language model creates word embeddings 312 of the free-form text 310, for use by the enriched language model 308 and by a sequence model 314).

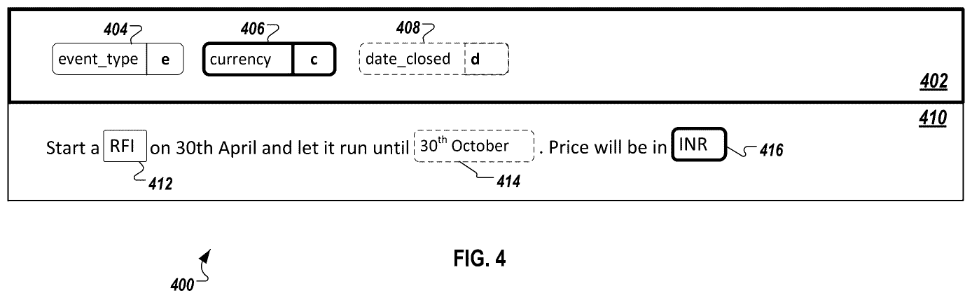

The sequence model 314 can be trained to extract sourcing event field information from the free-form text 310, for example. In a training phase 316 for the sequence model 314, annotated text 318 is provided for training the sequence model 314. The annotated text 318 can include free text samples that have been annotated to identify sourcing event fields in the free text samples. Once the training completes, weights for the sequence model 314 can be stored and then later used to classify words during a tagging phase. Text annotation and training is described in more detail below with respect to FIG. 4.

The sequence model 314, in the tagging phase, can identify event parameters 320 (e.g., event field values) included in the free-form text 310. For instance, the sequence model 314 can identify event parameters 322, including an event type of RFP, a close date of Mar. 13, 2022, and a currency of USD, from the example free text instance 311. Although a sequence model is described, other types of models can be used, including large language models.

FIG. 4 illustrates an example user interface 400 for annotating example text with event field labels. Various type of approaches can be used to annotate example text, such as manual insertion of labels or tags into respective text samples or by using a graphical user interface such as the user interface 400. The user interface 400 includes a label area 402 that includes example symbols 404, 406, and 408 representing event_type, currency, and date_closed sourcing event fields, respectively. The label area 402 can include other symbols representing other types of event fields.

The user interface 400 includes a labeling area 410 in which a user can apply labels to sample free form text (e.g., training data) to create annotated text. The user interface 400 can include various types of mechanisms to load sample free form text instances into the labeling area in preparation for labeling of the sample free form text. Different instances of sample free form text can be different historical instances of requests to create sourcing events, for example.

Different approaches can be used to apply respective labels. For instance, a user can drag and drop a respective symbol 404, 406, or 408 onto a respective text token displayed in the labeling area 410 to apply a label corresponding to the symbol. As another example, the user can select a respective text token and then select a respective symbol 404, 406, or 408 or provide a respective user input (e.g., “e”, “c”, or “d”) that is preconfigured in the user interface 400 to apply a respective label corresponding to the symbol 404, 406 or 408, respectively, to the selected text token. In the example of FIG. 4, the user has applied an event_type label to an “RFI” text token 412, a date_closed label to a date text token 414, and a currency label to an INR text token 416. Different styles of the symbols 404, 406, and 408 and matching styles applied to the text tokens 412, 414, and 416, respectively, provide visual cues to the user as to which types of labels have been applied to different text tokens.

FIG. 5 illustrates an example system for automatic sourcing event template selection. A sourcing event template can include predefined rules, settings, terms, or other content that may be applied to the sourcing event. An organization can use templates to reuse certain configurations for multiple instances of similar sourcing events, for example.

A sourcing system can identify historical data 502 for use in training a template recommendation model 504. The historical data 502 can include sourcing features of historical sourcing events, line items for those sourcing events, including terms mentioned in the sourcing features and line items. Sourcing features can include commodity, category, department, currency, baseline spend, line item information, or other sourcing event fields of historical sourcing events. Sourcing features can also include recency data for dates of historical selections of sourcing event templates.

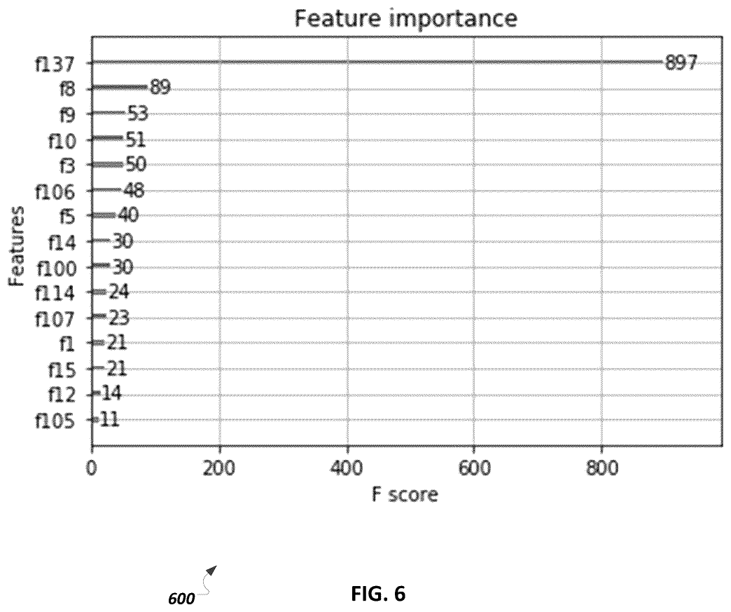

The historical data 502 can undergo preprocessing 506 (e.g., stemming, normalization, vectorization) and can be used in a XGBoost/Convolution XGBoost training phase 508 of the template recommendation model 504. The template recommendation model 504 can use XGBoost or other types of AI/ML approaches. The template recommendation model 504 can be trained to recommend a best template based on learned patterns, feature weights, feature importance, etc. of the historical data 502. Use of different features scores/weights is described below with respect to FIG. 6. Different instances of the template recommendation model 504 can be trained for different organizations.

After training, the sourcing system can obtain real-time data 510, such as sourcing event fields (and possibly line item information) for a requested sourcing event. Various features of the requested sourcing event can be identified. Features identified for the requested sourcing event can be of similar feature types as described above for the historical data 502. As described above, the sourcing event fields and line item information for a requested sourcing event can be extracted (e.g., from a free-text message) by an extraction model, such as the sourcing event field extraction engine 122. The real-time data 510 can also undergo preprocessing 506. The real-time data 510 (after possible pre-processing) can be provided to a trained version of the template recommendation model 504. The template recommendation model 504 can determine a recommended template 512 for the requested sourcing event corresponding to the real-time data 510. The recommended template 512 can be specified as a template for a sourcing event object that is created in response to the request to create the sourcing event.

FIG. 6 illustrates example features 600 for automatic sourcing event template selection. The features 600 are shown sorted by a feature score (e.g., feature weight). The template recommendation model 504 can be configured using the displayed feature scores/weights, based on the feature scores being learned in a training phase of the template recommendation model 504, based on features present in the historic data 502. As described above, features can include features related to commodity, category, department, currency, baseline spend, line item information, or other sourcing event field data. In general, a feature score for a feature can indicate how strongly a presence (or in some cases, a non-presence) of a given feature of an upcoming sourcing event can determine a best sourcing event template for the sourcing event for an organization. For example, during training of the template recommendation model 504, a commodity feature may be identified as most important for predicting a best sourcing event template, and may thus be given a highest feature score. A region feature may given a next highest feature score, and other features that are determined, during training of the template recommendation model, to be less important for identifying a best template may be given lower feature scores. Different organizations can have different feature scores. A sourcing event template recommendation model can be configured based on the feature scores (or in some cases, on feature scores of a certain number of top scoring features). As mentioned above for FIG. 5, features can include commodity, category, department, currency, baseline spend, line item information, or other sourcing event fields of historical sourcing events. Features can also include recency data for dates of historical selections of sourcing event templates.

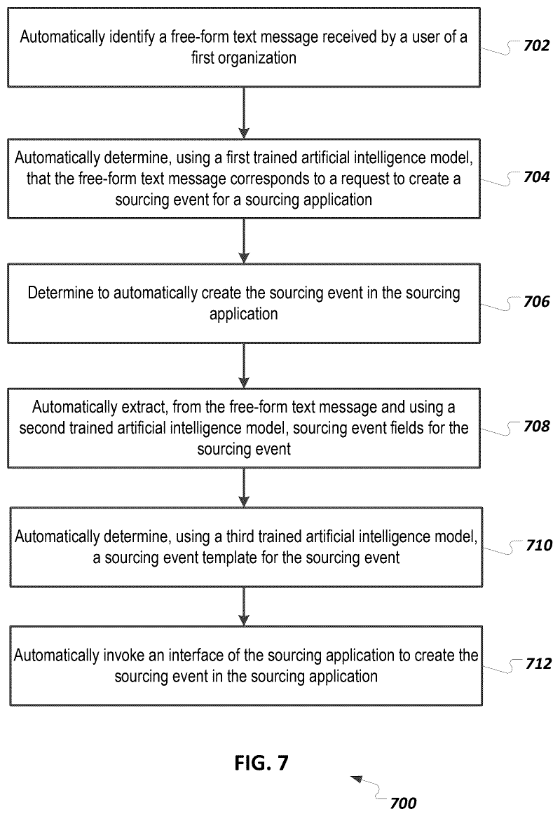

FIG. 7 is a flowchart of an example method 700 for creating sourcing event objects from free-form data. It will be understood that method 700 and related methods may be performed, for example, by any suitable system, environment, software, and hardware, or a combination of systems, environments, software, and hardware, as appropriate. For example, one or more of a client, a server, or other computing device can be used to execute method 700 and related methods and obtain any data from the memory of a client, the server, or the other computing device. In some implementations, the method 700 and related methods are executed by one or more components of the system 100 described above with respect to FIG. 1. For example, the method 700 and related methods can be executed by the sourcing system 102 of FIG. 1 or another type of system.

At 702, a free-form text message received by a user of a first organization is automatically identified. The free-form text message can be an email message, a chat message, or another type of free-form message or data. The free-form text message can be identified after receiving consent from the user to automatically analyze free-form text messages received by the user.

At 704, an automatically determination is made, using a first trained artificial intelligence model, that the free-form text message corresponds to a request to create a sourcing event for a sourcing application. The first trained artificial intelligence model can be a naïve Bayes model that is trained on a corpus of training data.

At 706, a determination is made to automatically create the sourcing event in the sourcing application. For example, a determination can be made that a confidence level generated by the first trained artificial intelligence model is more than a threshold. As another example, a request can be sent to the user, in response to determining that the free-form text message corresponds to a request to create a sourcing event, that requests the user to respond whether the sourcing event should be automatically created. A response can be received from the user that indicates that the sourcing event should be automatically created.

At 708, sourcing event fields for the sourcing event are automatically extracted from the free-form text message using a second trained artificial intelligence model. The second trained artificial intelligence model can be or include a sequence model, a Softmax layer, and/or a large language model. The extracted sourcing event fields for the sourcing event can include event type, opening date, closing date, and currency.

At 710, a sourcing event template for the sourcing event is automatically determined using a third trained artificial intelligence model.

At 712, an interface of the sourcing application is automatically invoked to create the sourcing event in the sourcing application. Sourcing event fields extracted from the free-form text message and an indication of the sourcing event template determined by the third trained artificial intelligence model can be provided to the interface of the sourcing application. A notification can be sent to the user regarding creation of the sourcing event in the sourcing application.

The first trained artificial intelligence model, the second trained artificial intelligence model, and the third trained artificial intelligence model can be trained for the first organization which results in determination of different weights for the first organization for the first trained artificial intelligence model, the second trained artificial intelligence model, and the third trained artificial intelligence model than weights determined for a second organization.

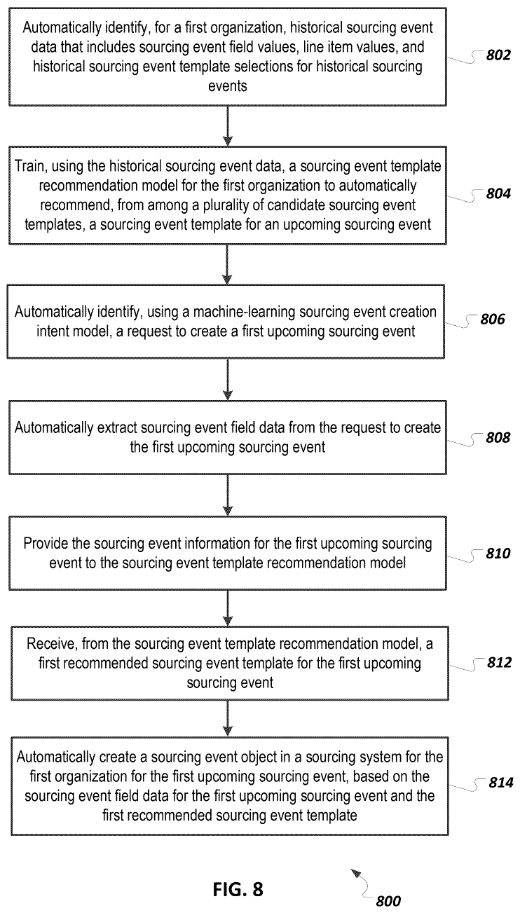

FIG. 8 is a flowchart of an example method 800 for automatic sourcing event template selection. It will be understood that method 800 and related methods may be performed, for example, by any suitable system, environment, software, and hardware, or a combination of systems, environments, software, and hardware, as appropriate. For example, one or more of a client, a server, or other computing device can be used to execute method 800 and related methods and obtain any data from the memory of a client, the server, or the other computing device. In some implementations, the method 800 and related methods are executed by one or more components of the system 100 described above with respect to FIG. 1. For example, the method 800 and related methods can be executed by the sourcing system 102 of FIG. 1 or another type of system.

At 802, historical sourcing event data that includes sourcing event field values, line item values, and historical sourcing event template selections for historical sourcing events is automatically identified for a first organization. The historical sourcing event data can be pre-processed, such as by normalizing data, removing duplicates, etc.

At 804, a machine-learning sourcing event template recommendation model for the first organization is trained, using the historical sourcing event data, to automatically recommend, from among a plurality of candidate sourcing event templates, a sourcing event template object for an upcoming sourcing event. Training the machine-learning sourcing event template recommendation model can include determining feature weights, for sourcing event template recommendation for the first organization, of features in the historical sourcing event data. The feature weights can identify features that can determine, for the first organization, a best sourcing event template for an upcoming sourcing event. The features can include commodity, category, department, currency, baseline spend, and line item information of historical sourcing events. The features can include recency data for historical selections of sourcing event templates. The machine-learning sourcing event template recommendation model can be or include a XG Boost model and/or a convolutional XG Boost model.

At 806, a request to create a first upcoming sourcing event is automatically identified, using a machine-learning sourcing event creation intent model. The request to create the sourcing event can be or include a free-form text message.

At 808, in response to automatically identifying the request to create the first upcoming sourcing event, sourcing event field data can be automatically extracted, using a machine-learning automatic sourcing event field extraction model, from the request to create the first upcoming sourcing event.

At 810, the extracted sourcing event field data for the first upcoming sourcing event is provided to the machine-learning sourcing event template recommendation model.

At 812, a first recommended sourcing event template for the first upcoming sourcing event is received from the machine-learning sourcing event template recommendation model.

At 814, a sourcing event object is automatically created in a sourcing system for the first organization for the first upcoming sourcing event, based on the extracted sourcing event field data for the first upcoming sourcing event and the first recommended sourcing event template. In some examples, a recommendation to use the first recommended sourcing event template can be provided to a user of the first organization. A confirmation can be received from the user for using the first recommended sourcing event template. The sourcing event object for the first upcoming sourcing event can be created based on the first recommended sourcing event template in response to receiving the confirmation.

The machine-learning sourcing event template recommendation model can provide a second recommended sourcing event template for a second upcoming sourcing event. A recommendation to use the second recommended sourcing event template for the second upcoming sourcing event can be provided to a user of the first organization. A rejection can be received from the user regarding using the second recommended sourcing event template for the second upcoming sourcing event. The sourcing event template recommendation model can determine, in response to the rejection, a third recommended sourcing event template for the second upcoming sourcing event. The machine-learning sourcing event template recommendation model can be updated based on the rejection.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
automatically identifying, for a first organization, historical sourcing event data that includes sourcing event field values, line item values, and historical sourcing event template selections for historical sourcing events;
training, using the automatically-identified historical sourcing event data, a machine-learning sourcing event template recommendation model for the first organization to automatically recommend, from among a plurality of candidate sourcing event templates, a sourcing event template object for an upcoming sourcing event;
automatically identifying, using a machine-learning sourcing event creation intent model, a request to create a first upcoming sourcing event;
in response to automatically identifying the request to create the first upcoming sourcing event, automatically extracting, using a machine-learning automatic sourcing event field extraction model, extracted sourcing event field data from the request to create the first upcoming sourcing event;
providing extracted sourcing event field data for the first upcoming sourcing event to the machine-learning sourcing event template recommendation model;
receiving, from the machine-learning sourcing event template recommendation model, a first recommended sourcing event template for the first upcoming sourcing event; and
automatically creating a sourcing event object in a sourcing system for the first organization for the first upcoming sourcing event, based on the extracted sourcing event field data for the first upcoming sourcing event and the first recommended sourcing event template.

2. The computer-implemented method of claim 1, further comprising preprocessing the historical sourcing event data.

3. The computer-implemented method of claim 1, wherein training the machine-learning sourcing event template recommendation model comprises determining feature weights, for sourcing event template recommendation for the first organization, of features in the historical sourcing event data.

4. The computer-implemented method of claim 3, wherein the feature weights identify features that can determine, for the first organization, a best sourcing event template for an upcoming sourcing event.

5. The computer-implemented method of claim 3, wherein the features include commodity, category, department, currency, baseline spend, and line item information of historical sourcing events.

6. The computer-implemented method of claim 3, wherein the features include recency data for historical selections of sourcing event templates.

7. The computer-implemented method of claim 1, wherein the machine-learning sourcing event template recommendation model comprises a XG Boost model.

8. The computer-implemented method of claim 1, wherein the machine-learning sourcing event template recommendation model comprises a convolutional XG Boost model.

9. The computer-implemented method of claim 1, wherein the request to create the first upcoming sourcing event comprises a free-form text message.

10. The computer-implemented method of claim 1, further comprising:
providing a recommendation to use the first recommended sourcing event template to a user of the first organization; and
receiving confirmation from the user for using the first recommended sourcing event template; and
wherein the sourcing event object for the first upcoming sourcing event is created based on the first recommended sourcing event template in response to receiving the confirmation.

11. The computer-implemented method of claim 1, further comprising:
receiving, from the machine-learning sourcing event template recommendation model, a second recommended sourcing event template for a second upcoming sourcing event;
providing a recommendation to use the second recommended sourcing event template for the second upcoming sourcing event to a user of the first organization; and
receiving a rejection from the user regarding using the second recommended sourcing event template for the second upcoming sourcing event.

12. The computer-implemented method of claim 11, further comprising determining, by the machine-learning sourcing event template recommendation model, in response to the rejection, a third recommended sourcing event template for the second upcoming sourcing event.

13. The computer-implemented method of claim 11, further comprising updating the machine-learning sourcing event template recommendation model based on the rejection.

14. A system, comprising:
a computing device; and
a computer-readable storage device coupled to the computing device and having instructions stored thereon which, when executed by the computing device, cause the computing device to perform operations comprising:
automatically identifying, for a first organization, historical sourcing event data that includes sourcing event field values, line item values, and historical sourcing event template selections for historical sourcing events;
training, using the automatically-identified historical sourcing event data, a machine-learning sourcing event template recommendation model for the first organization to automatically recommend, from among a plurality of candidate sourcing event templates, a sourcing event template object for an upcoming sourcing event;
automatically identifying, using a machine-learning sourcing event creation intent model, a request to create a first upcoming sourcing event;
in response to automatically identifying the request to create the first upcoming sourcing event, automatically extracting, using a machine-learning automatic sourcing event field extraction model, extracted sourcing event field data from the request to create the first upcoming sourcing event;
providing extracted sourcing event field data for the first upcoming sourcing event to the machine-learning sourcing event template recommendation model;
receiving, from the machine-learning sourcing event template recommendation model, a first recommended sourcing event template for the first upcoming sourcing event; and
automatically creating a sourcing event object in a sourcing system for the first organization for the first upcoming sourcing event, based on the extracted sourcing event field data for the first upcoming sourcing event and the first recommended sourcing event template.

15. The system of claim 14, wherein training the machine-learning sourcing event template recommendation model comprises determining feature weights, for sourcing event template recommendation for the first organization, of features in the historical sourcing event data.

16. The system of claim 15, wherein the feature weights identify features that can determine, for the first organization, a best sourcing event template for an upcoming sourcing event.

17. The system of claim 16, wherein the features include commodity, category, department, currency, baseline spend, and line item information of historical sourcing events.

18. A non-transitory computer-readable storage medium coupled to one or more processors and having instructions stored thereon which, when executed by the one or more processors, cause the one or more processors to perform operations comprising:
automatically identifying, for a first organization, historical sourcing event data that includes sourcing event field values, line item values, and historical sourcing event template selections for historical sourcing events;
automatically identifying, for a first organization, historical sourcing event data that includes sourcing event field values, line item values, and historical sourcing event template selections for historical sourcing events;
training, using the automatically-identified historical sourcing event data, a machine-learning sourcing event template recommendation model for the first organization to automatically recommend, from among a plurality of candidate sourcing event templates, a sourcing event template object for an upcoming sourcing event;
automatically identifying, using a machine-learning sourcing event creation intent model, a request to create a first upcoming sourcing event;
in response to automatically identifying the request to create the first upcoming sourcing event, automatically extracting, using a machine-learning automatic sourcing event field extraction model, extracted sourcing event field data from the request to create the first upcoming sourcing event;
providing extracted sourcing event field data for the first upcoming sourcing event to the machine-learning sourcing event template recommendation model;
receiving, from the machine-learning sourcing event template recommendation model, a first recommended sourcing event template for the first upcoming sourcing event; and
automatically creating a sourcing event object in a sourcing system for the first organization for the first upcoming sourcing event, based on the extracted sourcing event field data for the first upcoming sourcing event and the first recommended sourcing event template.

19. The computer-readable storage medium of claim 18, wherein training the machine-learning sourcing event template recommendation model comprises determining feature weights, for sourcing event template recommendation for the first organization, of features in the historical sourcing event data.

20. The computer-readable storage medium of claim 19, wherein the feature weights identify features that can determine, for the first organization, a best sourcing event template for an upcoming sourcing event.
